(19) United States
(12) Patent Application Publication
(10) Pub. No.: US 2004/0059732 A1
(43) Pub. Date: Mar. 25, 2004

(54) Method for searching for, selecting and mapping web pages

(75) Inventor: Christophe Vaucher, Bandol (FR)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Linkkit S.A.R.L.

(21) Appl. No.: 10/436,599

(22) Filed: May 13, 2003

Related U.S. Application Data
(63) Continuation of application No. PCT/FR01/03561, filed on Nov. 14, 2001.

(30) Foreign Application Priority Data
Nov. 15, 2000 (FR) 00 14744

(51) Int. Cl. G06F 7/00

(52) U.S. Cl. 707/5

(57) ABSTRACT

The present invention relates to a method for searching for and selecting Web pages in conjunction with a search equation, including a step of determining, through at least one search engine, an initial set of Web pages, and a step of determining a first set of Web sites including sites corresponding to the Web pages of the initial set. Sites are linked by intersite links, and one site is linked to another site by an intersite link when there is one or more hypertext links between Web pages of the two sites considered. At least one filtering operation based on the intersite links is provided, applied to the first set of sites and eliminates sites linked to the other sites of the first set of sites by less than N_{L} intersite links. N is a filter parameter at least equal to 1 in order to obtain at least a first reduced set of sites comprising at least one core of rank N_{L} of the first set of sites.

### CROSS-REFERENCE TO RELATED APPLICATIONS

This application is a continuation of International Application No. PCT/FR01/03561, filed Nov. 14, 2001, and the disclosure of which is incorporated herein by reference.

### BACKGROUND OF THE INVENTION

The present invention relates to browsing on the Internet and more particularly to searching for Web pages in conjunction with a search equation.

In recent years, the rapid development of the Internet and more particularly of the part of the Internet that is accessible to the public called the “Web” (World Wide Web), has led to a substantial development of tools designed to facilitate the search for information that include search engines and directories. Directories enable Web pages to be found from a classification of pages done manually by human operators. Search engines are computer “robots” that explore all the pages of the Web and enable Web pages to be found using a search equation, and thus “to find one's way” around the huge set of Web sites that the Internet represents. Therefore, various tools such as Alta Vista, Yahoo!, Lycos, Excite, Google, and the like, having great computing power are currently accessible to the public using any microcomputer equipped with a connection to the Internet and a browser (ALTA VISTA is a registered U.S. Trademark of Digital Equipment Corporation, Maynard, Mass. 01754; YAHOO! is a registered U.S. Trademark of YAHOO! Inc., Santa Clara, Calif. 95051; Lycos is a registered U.S. Trademark of Carnegie Mellon University, Pittsburgh, Pa. 15213; Excite is a registered U.S. Trademark of Excite, Inc., Mountain View, Calif. 94043; and Google is a registered Trademark of Google, Inc., Mountain View, Calif. 94043).

In practice, a search engine consists of one or more computers that have a substantial database in which millions of Web pages are indexed, which is enhanced and updated constantly by incursions of the search engine into the Web. For each Web page indexed, the information stored in the database generally comprises the address (URL) and the content of the page, the title and the key words describing the Web site to which the page is attached, the popularity index of the page (indicator established using the number of Web pages designating the page by hypertext links), the addresses of the Web pages designated by the hypertext links contained in the page, etc.

In response to a search equation comprising one or more combined key words, a search engine selects relevant Web pages in its database by applying various selection criteria that can vary from one search engine to another but are generally based on the number of occurrences of the terms of the search equation in the pages examined, their position in the pages, the analysis of tags (key words present in the pages, title of the pages, etc.) and the popularity index of the pages. The result of the search is sent back in the form of a list of Web pages, each page being presented to the user in the form of a hypertext address (URL) often with other information such as a summary of the page, the position of the key word or words of the search equation in their context within the page, etc.

One well-known disadvantage of search engines is that the list of Web pages sent back to the user is generally very long and may comprise hundreds of pages arranged in an order of relevance that in practice rarely proves to be satisfactory. The user therefore has to read the information provided with the address of each page and, in most cases, “visit” many pages out of the proposed list before finding the one sought or the one he is most interested in.

### BRIEF SUMMARY OF THE INVENTION

The present invention comprises a method enabling the number of Web pages presented to a user in response to a search equation to be reduced, that is simple to implement while being statistically reliable in terms of the relevance of the pages chosen.

The present invention also comprises a method for selecting Web pages in an initial set of pages that may comprise very many Web pages selected by means of one or more search engines.

The present invention is based on the premise according to which a page designated by many other pages and/or designating many other pages is likely to be more relevant than an isolated page without links to the other pages on the Web. Since the analysis of the hypertext links existing in a set of Web pages is complex to perform and requires considerable computing power, a first idea of the present invention is to reduce an initial set of Web pages to a first set of Web sites in which the sites are linked by intersite links. Another idea of the present invention is to apply a filtering operation based on the intersite links to the Web sites of such a set of sites, to obtain a result set comprising a reduced number of sites, forming one or more cores of the initial set.

Therefore, in essence, the present invention provides a method for searching for and selecting Web pages in conjunction with a search equation, comprising a step of determining, through at least one search engine, an initial set of Web pages, a step of determining a first set of Web sites comprising sites corresponding to the Web pages of the initial set, wherein sites are linked by intersite links, one site being linked to another site by an intersite link when there is at least one hypertext link between Web pages of the two sites considered, and at least one filtering operation based on the intersite links, applied to the first set of sites and comprising the elimination of sites linked to the other sites of the first set of sites by less than N_{L} intersite links, N being a filter parameter at least equal to 1, to obtain at least a first reduced set of sites comprising at least one core of rank N_{L} of the first set of sites.

According to one embodiment, a site is linked to another site by a single intersite link when there are several hypertext links in the same direction between Web pages of the two sites considered.

According to one embodiment, a site is linked to another site by a single intersite link when there are hypertext links in opposite directions between Web pages of the two sites considered.

According to one embodiment, the filtering operation is conducted by pruning and comprises repeating a step of eliminating sites linked by less than N intersite links, for increasing values of N starting with an initial value N₀ and at least up to the value N_{L}, that defines a filter depth.

According to one embodiment, the method comprises at least a second filtering operation applied to the first set of sites from which the sites belonging to the first reduced set of sites are removed, to obtain at least a second reduced set of sites comprising lower-ranking cores formed by sites linked by less than N_{L} intersite links.

According to one embodiment, the method comprises a step of weighting the intersite links of the first set of sites, including allocating a determined weight to each intersite link.

According to one embodiment, the method comprises weighting the sites by allocating each site a weight equal to the sum of the weights of the intersite links contained in the site considered.

According to one embodiment, weighting an intersite link comprises a step of allocating a determined weight to the hypertext links linking the respective pages of two sites considered, and a step of adding up the weights of each of the hypertext links that underlie the intersite link.

According to one embodiment, an intersite link is weighted according to the rank of the core or cores within which the sites linked by the intersite link come.

According to one embodiment, the method comprises a step of ranking sites according to the weights of their intersite links.

According to one embodiment, the method comprises a step of presenting, on display means, the sites of at least one reduced set of sites or the pages of the initial set of pages belonging to the sites of at least one reduced set of sites.

According to one embodiment, the method comprises presenting Web sites on display means in the form of user-selectable interactive objects, the selection of a site object by a user triggering the display, in the form of selectable interactive objects, of the Web pages belonging to the selected site and to the initial set of pages.

According to one embodiment, the method comprises presenting Web sites on display means, with display of the intersite links in a visual form that can be understood by a user.

According to one embodiment, the steps of determining an initial set of pages and a first set of sites comprise the steps of: searching for pages likely to be relevant with regard to a search equation, to form a first primary set of pages, determining the sites that correspond to the pages of the first primary set of pages, to form a first primary set of sites, searching for pages linked to the pages of the first primary set of pages and/or to the sites of the first primary set of sites by hypertext links, to form at least a second primary set of pages, determining the sites that correspond to the pages of the second primary set of pages, to form at least a second primary set of sites, merging the first and the second primary sets of pages to form the initial set of pages, and merging the first and the second primary sets of sites to form the first set of sites.

According to one embodiment, the second primary set of pages comprises pages designating pages belonging to the sites of the first primary set of sites.

According to one embodiment, the second primary set of pages comprises pages designated by pages belonging to the sites of the first primary set of sites.

The present invention also relates to a digital computer, programd to execute the method according to the present invention.

The present invention also relates to a computer program recorded on a medium and loadable into the memory of a digital computer, containing program codes executable by the computer, arranged to execute the steps of the method according to the present invention.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flowchart describing the general organization of the method according to the present invention;

FIG. 2 schematically represents the Internet and shows an example of implementation of the method according to the present invention;

FIG. 3 is a flowchart describing steps of forming an initial set of Web pages and a first set of Web sites;

FIG. 4 schematically shows the method described by the flowchart in FIG. 3;

FIGS. 5A to 5B show a method of determining intersite links and of weighting these links according to the present invention;

FIG. 6 shows a simplified example of a set of Web sites comprising sites linked by intersite links;

FIG. 7 shows a filtering method according to the present invention;

FIG. 8 is a flowchart describing the filtering method according to the present invention; and

FIGS. 9A to 9C show a step of mapping the result of a filtering operation according to the present invention.

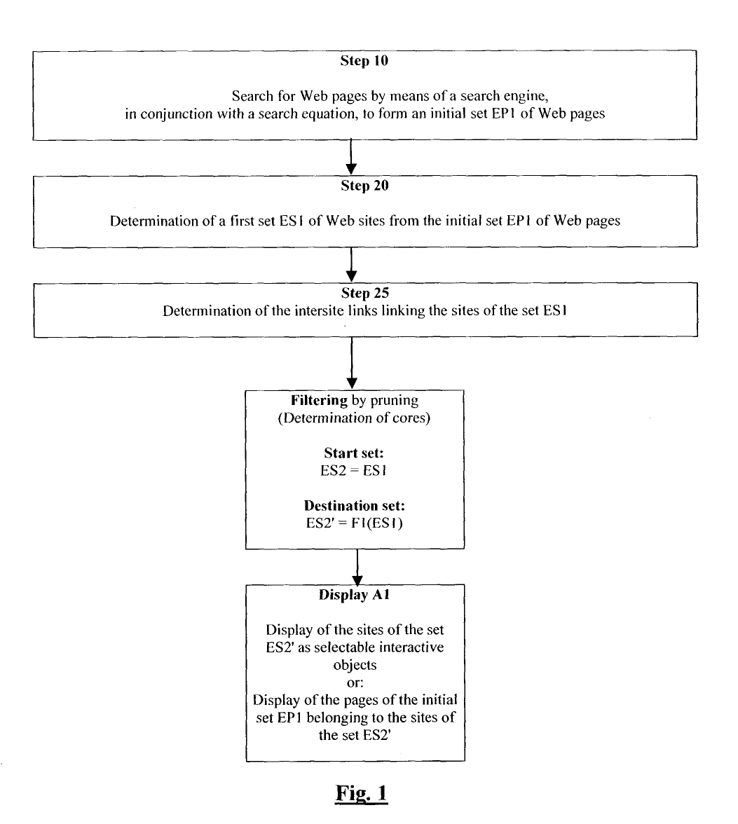

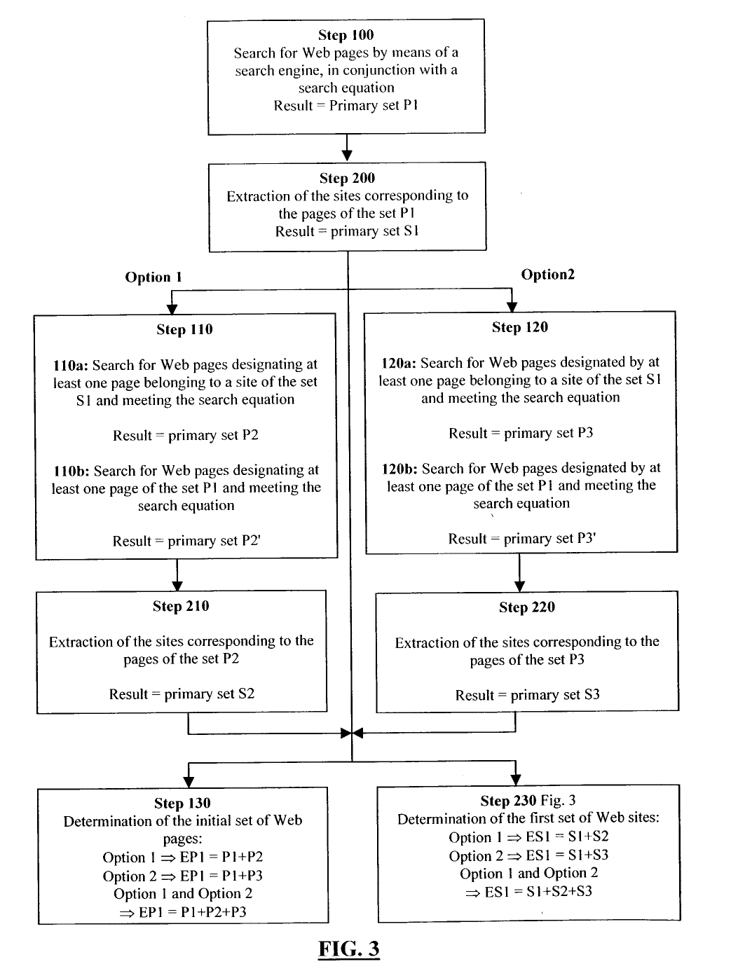

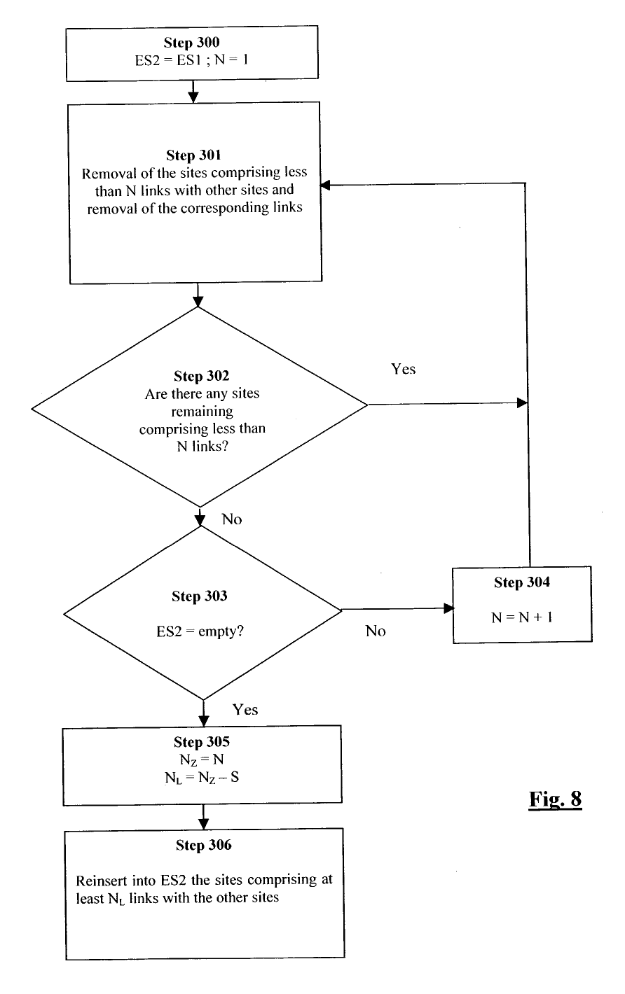

In the description below, the method according to the present invention will also be described with reference to the tables given in Annex 3, which are an integral part of the description, table 1 corresponding to the flowchart in FIG. 1, table 2 corresponding to the flowchart in FIG. 3, and table 3A corresponding to the flowchart in FIG. 8.

### DETAILED DESCRIPTION OF THE INVENTION

General presentation of the method according to the present invention

The flowchart in FIG. 1 describes the general organization of the method for searching for and selecting Web pages according to the present invention. There are two preliminary steps 10, 20 for forming a first set ES1 of Web sites. The step 10 aims to form an initial set EP1 of Web pages using a search equation and the step 20 aims to form a first set ES1 of sites corresponding to the pages of the initial set EP1. In a step 25, the intersite links between the sites of the set ES1 are determined. After forming the set of sites ES1 and determining the intersite links, the method according to the present invention comprises a filtering step called “filtering to search for cores” that is applied to a set of Web sites referenced ES2, initially containing all or part of the sites of the set ES1. After filtering, a reduced set of sites ES2′ is obtained comprising a small number of sites forming one or more cores of the set ES1, the number of sites depending firstly on the topography of the first set of sites ES1 and secondly on the filter depth chosen.

Generally speaking, the filtering can enable several results to be obtained, by changing the parameters of the filtering or the topography of the starting set, such that several result sets can be obtained.

Again with reference to FIG. 1, the filtering step is followed by an operation of displaying the result or results of filtering. According to one aspect of the present invention, this display includes presenting the sites selected in the form of interactive site objects, with the possibility of viewing the Web pages of the initial set EP1 by selecting the site objects by means of a monitor pointer, then selecting the Web pages viewed to directly access these pages. This interactive presentation of the results constitutes an effective and practical man-machine interface to find Web pages sought, as will be clearly understood subsequently.

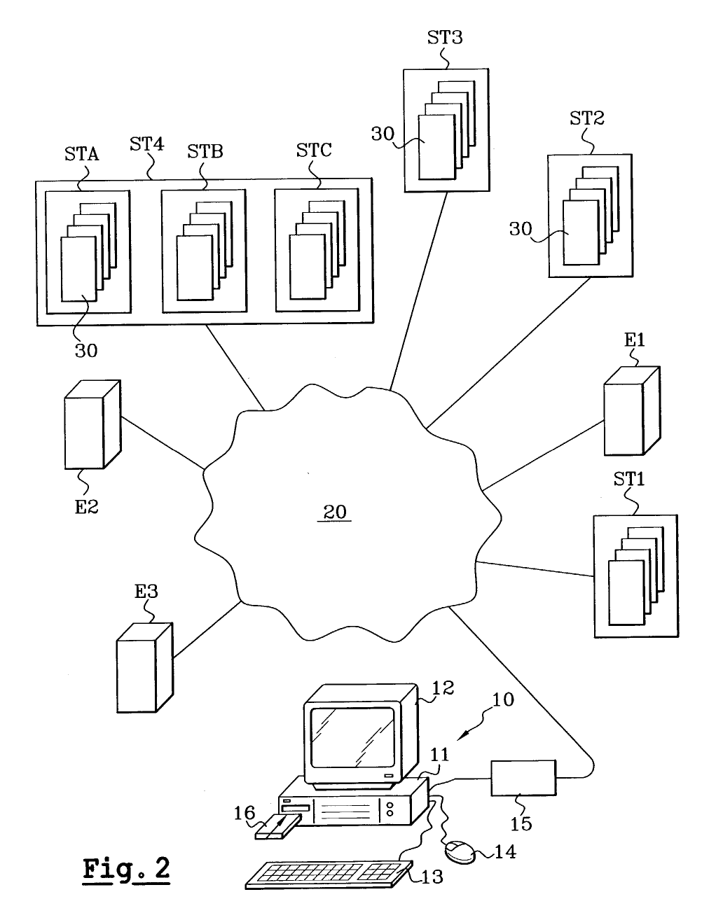

Before describing these various aspects of the method according to the present invention in greater detail, reference shall be made to FIG. 2 which schematically represents the Internet and an example of an implementation of this method.

Implementation of the Method According to the Present Invention

In the following description it will be considered, without limitation, that the method according to the present invention is executed by a microcomputer 10 that is connected to the Internet 20 and can access various search engines and various Web sites. Three search engines E1, E2, E3 and four Web sites ST1, ST2, ST3, ST4 are represented in FIG. 1, the site ST4 being a host site receiving sites STA, STB and STC.

The microcomputer 10 classically comprises a central processing unit 11, a monitor 12, a keyboard 13, a mouse 14 or any other means of controlling a monitor pointer, and a means of connecting 15 to the Internet such as a modem or a router. The central processing unit 11 comprises various elements not represented but well known to those skilled in the art, particularly a microprocessor, a random access memory RAM, a read-only Memory ROM and/or a FLASH-Type electronically erasable programable read only memory EEPROM receiving the operating system of the microprocessor, and a secondary memory such as a hard disk, receiving the operating system of the microcomputer and various application programs. The secondary memory particularly comprises a program for browsing the Web and a program for searching for and selecting Web sites according to the present invention. This program is loaded into the hard disk of the central processing unit by means of a program medium, such as a CD-ROM or DVD-ROM 16 for example. The program according to the present invention can also be loaded into the central processing unit through a private Intranet. It could also, in the future, be downloaded through the Internet.

Reminders About the Syntactic Parsing of the Addresses of Web Pages

In FIG. 2, each site represented ST1 to ST4 comprises a plurality of Web pages 30 directly accessible by means of their addresses, called “URL” (Uniform Resource Locator). To fully understand the following description, it will be repeated here that the address of a Web site generally constitutes the stem of the addresses of the pages of that site. The address of a Web site can be extracted from the address of a Web page by searching for the stem of the address by means of a sub-program called a “parser”, which in itself is well known by those skilled in the art. The parser reads the address of the page starting with its first letter until it finds the first slash “/” after the two slashes “//” of the http (Hyper Text Transfer Protocol) root, which enables the address of the site to be extracted. In the case of certain hosted sites, the extraction of the address of the site using the address of a page requires continuing the parsing up to the second slash after the http root, as the first stem of the address of the pages is the address of the host site that it is not desirable to choose as the site address.

Forming an Initial Set of Web Pages and a First Set of Web Sites

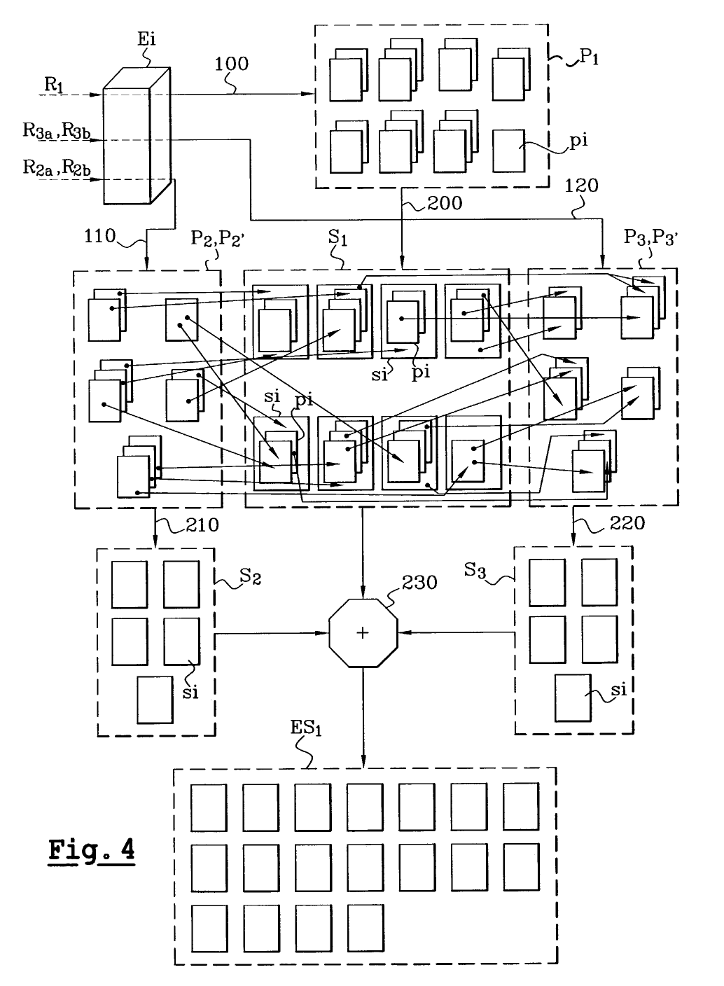

According to the present invention, these properties of the Internet addresses are used to define a first set of sites ES1 during the above-mentioned steps 10, 20, described in greater detail by the flowchart in FIG. 3 and schematically shown in FIG. 4.

The steps 10 and 20 respectively comprise steps 100 to 130 and 200 to 230 interlaced. The steps 100, 110 and 120 are steps of searching for Web pages and the steps 200, 210 and 220 are steps of extracting Web sites using the addresses of the Web pages found during the steps 100, 110 and 120. The steps 130 and 230 are steps of merging the results.

The search steps 100, 110 and 120 are conducted by means of a search engine Eᵢ, such as one of the engines E1, E2, E3 represented in FIG. 2 for example. In the step 100, the user writes out a question, or search equation R1, using the keyboard 13 of the microcomputer 10. The search equation is sent to the search engine Eᵢ by the central processing unit 11 and classically comprises one or more combined terms (letters, words, figures, symbols, etc.). In response to the search equation R1, the search engine E1 sends back the addresses of various Web pages, forming a first primary set P1 of Web pages represented in FIG. 4. The pages of the set P1 are extracted from the database of the search engine Eᵢ classically, for example according to the number of occurrences of the terms of the search equation in the pages examined, their position in the pages and various other criteria possibly differing from one search engine to another.

In the step 200, the central processing unit extracts the addresses of the sites sᵢ corresponding to the pages pᵢ of the set P1, by the above-mentioned parsing method, to form a primary set S1 of Web sites.

After the step 200, the steps 110, 210 (“option 1”) are in parallel with the steps 120 and 220 (“option 2”). In practice, the method according to the present invention can in fact be implemented by executing the steps 110 and 210 only or the steps 120 and 220 only. The steps 110, 210 and 120, 220 can also be combined.

The step 110 comprises a main step 10a and a complementary step 110b. In the step 110a, the central processing unit sends the search engine Eᵢ a series of requests R2a, each request being sent with the address of one of the sites sᵢ of the primary set S1. Each request R2a is a request for communication of the addresses of the Web pages that designate at least one page of the site sᵢ by hypertext links and which meet the search equation R1. The request R2a is for example made by means of a command LINK_{A} in the following way:

R2a=LINK_{A}<address of the site sᵢ>+<R1>−HOST<address of the site sᵢ>

and means: “find the pages that designate at least one page of the specified site sᵢ and which meet the search equation R1, save those that belong to the site sᵢ”. The preposition “save” corresponds to the command HOST that enables the central processing unit not to receive pages belonging to the site concerned in response to the request R2a so as not to over promote sites with a high rate of self-referencing, i.e. which comprise many pages mutually designating each other.

Upon each request R2a, the search engine Eᵢ sends back a list of addresses of Web pages that designate a page of the specified site sᵢ (along with information about these pages and about the sites they come within). It will be understood that this list can be empty if there are no Web pages that refer to the page concerned. When requests R2a have been sent for all the sites sᵢ of the set S1, the central processing unit has a second primary set of pages P2.

In the complementary step 110b, the central processing unit sends the search engine Eᵢ a series of requests R2b each with the address of a page pᵢ of the set P1. Each request R2b is a request for communication of the addresses of the Web pages that designate the specified page pᵢ by hypertext links and that meet the search equation R1. The request R2b is for example made in the following manner:

R2b=LINK_{A}<address of the page pᵢ>+<R1>−HOST<address of the site sᵢ>

and means: “find the pages that designate the specified page pᵢ and which meet the search equation R1, save those that belong to the site sᵢ containing the page pᵢ”. When requests R2b have been sent for all the pages pᵢ of the set P1, the central processing unit has a primary set P2′ that is solely made up of pages that designate pages belonging to the set P1 while meeting the search equation.

The set P2′ is included in the set P2 as the latter comprises pages that designate pages of the set P1 (set P2′) and pages that designate pages belonging to the sites of the set S1 but that do not belong to the set P1 (set P2 minus set P2′). It should be noted that the determination of the set P2′ during the step 110b aims to draw a distinction between two types of hypertext links, firstly those that point towards pages of the set P1 and secondly those that only point towards pages of a site of the set S1 that do not belong to the set P1. This distinction occurs in a step of weighting intersite links described below. However, the step 120a could be omitted in an embodiment of the method according to the present invention in which it is not desirable to note the hypertext links comprising a point of destination that does not belong to the set P1.

In the following step 210, the central processing unit determines the addresses of the sites corresponding to the pages of the set P2, again by parsing, to obtain a second primary set S2 of Web sites.

The steps 120 and 220 complete the steps 110 and 210 and aim to extract pages designated by pages belonging to the sites of the set S1. The step 120 comprises a main step 120a during which the central processing unit sends the search engine a series of requests R3a to form a set of pages P3, and a complementary step 120b during which the central processing unit sends the search engine a series of requests R3b to determine a set of pages P3′. The requests R3a and R3b are for example made by means of a command LINK_{B} aiming to search for pages designated downstream by hypertext links:

R3a=LINK_{B}<address of the site sᵢ>+<R1>−HOST<address of the site sᵢ>

R3b=LINK_{B}<address of the page pᵢ>+<R1>−HOST<address of the site sᵢ>

which respectively mean: “find the pages that designate a page of the specified site sᵢ and which meet the search equation R1, save those that belong to the site sᵢ”, and: “find the pages that designate the specified page pᵢ and which meet the search equation R1, save those that belong to the site sᵢ containing the page pᵢ”.

As it can be seen in FIG. 4, the set P3 comprises pages designated by pages of the set P1 (set P3′) as well as pages solely designated by pages that belong to the sites of the set S1 but which do not belong to the set P1 (set P3 minus set P3′). It will be understood that the step 120b could be omitted in an embodiment of the method according to the present invention wherein it is not desirable to note the hypertext links comprising a starting point that does not belong to the set P1.

In the step 220, the central processing unit determines the addresses of the sites corresponding to the pages of the set P3 to obtain a primary set S3 of Web sites.

The final steps 130 and 230 (only the step 230 is represented in FIG. 4) include merging the primary sets of pages and the primary sets of sites to respectively obtain the initial set of pages EP1 and the first set ES1 of Web sites, that will be used as a basis for the filtering. The term “merging” designates the fact of adding up the sets of pages and the sets of sites while eliminating the duplications. As represented in FIG. 4, the set ES1 is equal to the result of merging the sets S1, S2 and S3 if the options 1 and 2 are chosen simultaneously. Otherwise, the set ES1 is equal to the result of merging the sets S1 and S2 when only the option 1 is chosen or to the result of merging the sets S1 and S3 when only the option 2 is chosen. Again according to the option chosen, the initial set EP1 of Web pages calculated in the step 130 is equal to the result of merging the sets P1, P2 and P3, or to the result of merging the sets P1 and P2 or P1 and P3.

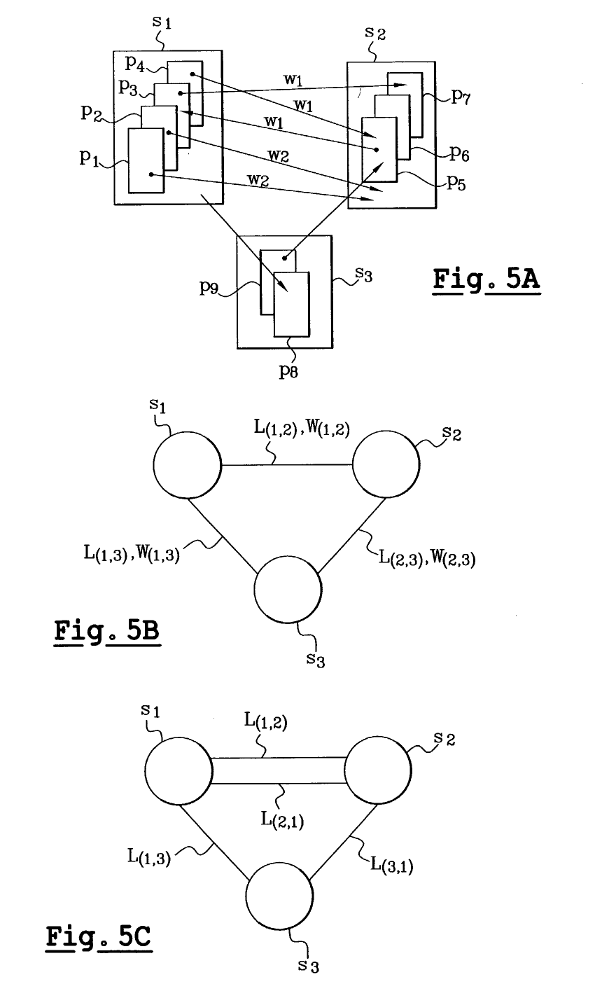

The central processing unit therefore has, at the end of these search steps, a first set of sites ES1 stored in the form of a matrix A comprising m columns and m rows, “m” designating the number of sites of the set ES1, so as to show the intersite links. For a better understanding, a set ESI will be considered for example with reference to FIG. 5A comprising three sites s1, s2, s3 comprising pages p1, p2, . . . p8 that belong to the set EP1 as well as pages that do not belong to the set EP1 (not represented). These various pages designate pages of the other sites by hypertext links. According to the present invention, a single intersite link is defined between two sites when there is at least one hypertext link between two pages of the sites considered, whatever the pages and whatever the direction of the hypertext link. Therefore, in FIG. 5B, each of the sites s1, s2, s3 is linked to the other sites by an intersite link, respectively L(1,2), L(1,3), L(2,3), as there is at least one hypertext link between two respective pages of each of the sites. A matrix A corresponding to the example of FIG. 5B is represented below as an example.

MATRIX A (simplified example)

| | |
|---|---|
| Reference site | Sites linked to the reference site |

| | | |
|---|---|---|
| s1 | s2 | s3 |
| s2 | s1 | s3 |
| s3 | s1 | s2 |

Similarly, the central processing unit has an initial set of pages EP1 stored in the form of a matrix B with n+m rows and n+m columns including the hypertext links, “n” designating the number of pages of the set EP1. If the set ES1 represented in FIG. 5A is considered again, the matrix B takes the form described below. In this matrix, the pages p(s1), p(s2), p(3) are anonymous pages that do not belong to the set EP1 although they belong to one of the sites s1, s2, s3 of the set ES1. Taking these pages into account enables hypertext links to be taken into account that have a starting point or a destination point page that does not belong to the set EP1, these links having been highlighted by the steps 110b and 120b described above. These hypertext links are taken into account firstly in the definition of the intersite links (but optionally) and secondly in the preferred mode of execution of the method of weighting intersite links described below.

MATRIX B (simplified example)

| Reference | | Other designated |
|---|---|---|
| pages | Designated pages belonging to the set EP1 | pages |
| p1 | | p(s2) |
| p2 | | p(s2) |
| p3 | p7 | |
| p4 | p5 | |
| p5 | p3 | |
| p6 | | |
| p7 | | |
| p8 | | |
| p9 | p5 | |
| p(s1) | p8 | |
| p(s2) | | |
| p(s3) | | |

It will be understood that alternative embodiments of the method according to the present invention may be made as far as the definition of the intersite links and the definition of the sets EP1 and ESI are concerned. As far as the definition of the sets EP1 and ES1 is concerned, one alternative includes extending the search for pages linked to those of the primary set P1 even further upstream and even further downstream, by searching for the pages that designate the pages of the set P2 and/or P3 and the pages that are designated by the pages of the set P3 and/or P2, etc. Furthermore, in one alternative shown in FIG. 5C, the transformation of the hypertext links into intersite links includes defining two intersite links when there are hypertext links in opposite directions between the two sites considered. Therefore, in FIG. 5C, the sites s1, s2 are linked by two intersite links L1,2 and L2,1 as there is at least one page of the site s1 that points towards a page of the site s2 and at least one page of the site s2 that points towards a page of the site s1. This alternate definition of the intersite links leads to a substantial modification in the topography of the set ES1 and is capable in certain cases of modifying the result of the filtering step. A filtering operation applied to a set of sites of the type represented in FIG. 5B and a filtering operation applied to a set of sites of the type represented in FIG. 5C could therefore be combined in one embodiment of the present invention in order to present the user with two complementary results.

Filtering to Search for Cores

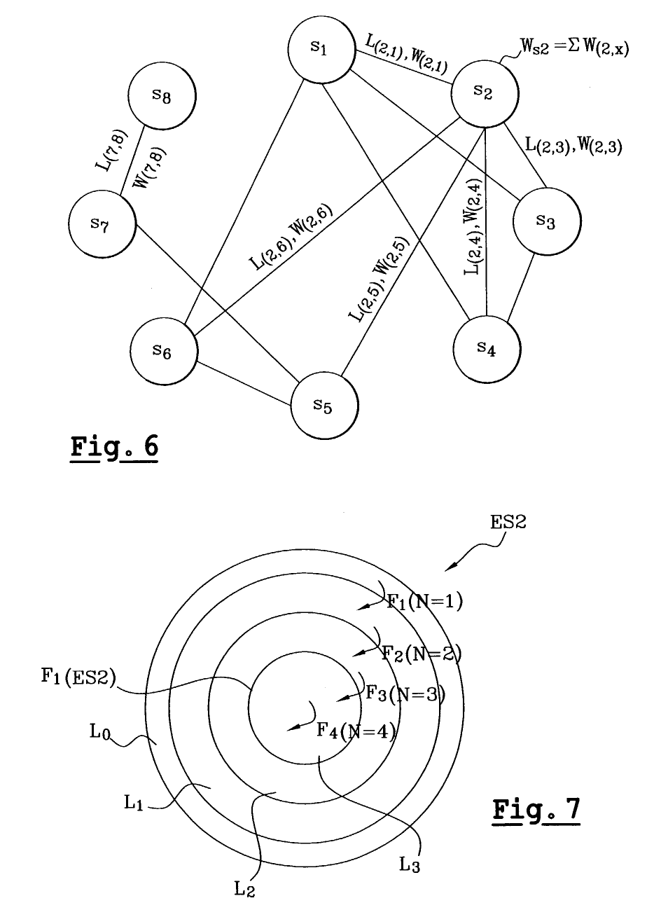

FIG. 6 schematically represents another example of a first set of sites ES1, to which reference will be made in the following description to show the filtering step. The set ES1 represented comprises a small number of sites sᵢ so that the Figure remains legible, and can in practice comprise hundreds or even thousands of sites. The set ES1 is represented in the form of a graph comprising “peaks” (sites sᵢ) linked by non-directed links that represent the intersite links or “pairs”.

The filtering operation, described by the flowchart in FIG. 8 and table 3A appended, is applied to a set of sites ES2 that is initially chosen equal to the set ES1 (step 300). However, a selection of sites out of the sites of the set ES1 can be provided before starting the filtering operation, such as a selection made by applying a preparatory filtering operation performed by means of any other algorithm for example.

The filtering includes performing a sort of pruning of the set ES2 and comprises a step 301 of eliminating the sites that are connected to the other sites by less than N intersite links, starting with an initial value N0, here fixed at 1, that is then incremented.

For each value of N, the removal step 301 must sometimes be repeated several times as the removal of sites having less than N links removes intersite links and generally shows new sites designated less than N times, which is detected during a step 302. With reference to the set ES2 represented in FIG. 6, it can be seen that the removal of the site s8 during the step of filtering the sites comprising less than 2 links (step 301 with N=2) results in the site s7 only comprising a single intersite link (linking it to the site s5), which is detected in the step 302. Therefore, the step 301 “searching for the sites comprising less than 2 links” is repeated, leading to the removal of the site s7.

The filter parameter N is incremented by one unit in a step 304 and the sites comprising less than 3 links are removed, such as the site s5 in FIG. 6 for example, then the site s6. After a certain number of increments of the parameter N, the central processing unit reaches then exceeds the core of the set ES2, such that the latter no longer contains any sites, which is detected in a verification step 303 that occurs before each step 304. At that time, the limit value N_{Z} for which there are no longer any sites in the set ES2 is known. A limit value N_{L} of the filter parameter N is then calculated during a step 305 by means of the relation:

N_{L}=N_{Z}−S,

in which “S” is a selectivity parameter defining the filter depth, the value of which is a natural number. The sites eliminated during the last “S” filter steps are reinserted into the set ES2 during a step 306, to form a reduced set designated ES2′, which is the result of the filtering.

The parameter S is preferably chosen to be equal to 1, so that the reduced set ES2′ comprises the highest-ranking core present in the set ES2. In practice, the set ES2 may comprise several independent cores each constituted by a group of sites linked to each other by N_{L} intersite links, it being possible for these cores to be linked to each other by less than N_{L} intersite links. In this case, the reduced set ES2′ comprises all the cores of the same rank N_{L} of the set ES2.

For a better understanding, the filtering process according to the present invention is shown in FIG. 7 that represents the set ES2 in the form of concentric layers. A layer L0 comprising the sites that are not designated by other sites, a layer L1 comprising the sites designated once after withdrawal of the layer L0, a layer L2 comprising the sites designated twice after withdrawal of the layer L1, and a layer L3 comprising the sites designated three times after withdrawal of the other layers can be distinguished, the layer L3 comprising the core or the cores of the set ES2. The layer L0 is removed by the filtering operation (N=1), the layer L1 is removed by the filtering operation (N=2) and the layer L2 is removed by the filtering operation (N=3). The layer L3 is removed by the filtering operation (N=4). If the parameter S is chosen equal to 1, only the layer L3 is reinserted into the set ES2 after the last filtering step. If the parameter S is chosen equal to 2, the core L3 and the layer L2 are reinserted into the set ES2 to form the reduced set ES2′.

In the example in FIG. 6, the core of the set ES2 is constituted by the sites s1, s2, s3 and s4 that are mutually connected by 3 links. These sites are removed by a filtering step in which N=4 and are then reinserted into the empty set by choosing N_{L}=3.

The reduced set ES2′ obtained at the end of the filtering operation is presented to the user during the display step described below.

Various alternatives and embodiments of this filtering method according to the present invention may be made. In particular, one alternative to the method for searching for the core is described by table 3B appended. This alternative includes replacing the step 303 of detecting the empty set by a step 303′ of determining the complexity of the set ES2, and stopping the filtering when the density of links is sufficiently high. The density of links can be assessed by means of the following complexity indicator DI:

DI=N_{LINK}/2[N_{SITE}(N_{SITE}−1)]

in which “N_{LINK}” is the number of links between the remaining sites of the set ES2 and “N_{SITE}” the number of remaining sites. The filtering is stopped when the indicator DI becomes higher than a value K representing the density sought. The limit value N_{L} of the filter parameter is the current value of N at the time the filtering is stopped.

Furthermore, according to one embodiment of the method according to the present invention, the filtering process is applied again to the set ES2 after removing the sites of the reduced set ES2′ from the set ES2, i.e. the core or cores highlighted by the first filtering. This second filtering enables one or more “sub-cores” or lower-ranking cores to be found that were eliminated during the first filtering, i.e. cores corresponding to a filter depth N_{L}′ that is lower than the one that enabled the highest-ranking core or cores (N_{L}) to be obtained. Therefore, a second reduced set ES2″ is obtained that contains sites the relevance of which is less in principle, but that can be presented to the user. This iterative filtering process can be continued by eliminating the sites belonging to the cores already found during the previous iterations each time from the initial set ES2. For example, the following iteration is applied to a set of sites equal to (ES2−ES2′−ES2″), and enables a third reduced set ES′″ to be found assumed to be even less relevant than the second reduced set ES2″.

In this way, one or more highest-ranking cores and one or more lower-ranking cores can be determined.

Other results can also be obtained by choosing the second definition of the intersite links described above in relation with FIG. 5C.

As it will be understood by those skilled in the art, the filtering operation according to the present invention does not require any complex mathematical calculation like a matrix product, and can therefore be performed by a PC type microcomputer of average power. In the matrix A representing the intersite links, the number of links that a site contains immediately appears by counting the number of sites located opposite the site concerned (by positioning oneself on the row on which the site concerned appears as a reference site). Similarly, the removal of a site during the filtering process includes removing the site from all the boxes of the matrix in which it is mentioned, and removing the row on which the site is located as a reference site. For example, it will be considered that the site s3 is removed from the matrix A described above. After removal, the matrix A is as follows:

MATRIX A after removal of the site s3

| Reference site | Sites linked to the reference site |
|---|---|
| s1 | s2 |
| s2 | s1 |

Weighting Intersite Links

The filtering step that has just been described can be combined with a step of weighting the intersite links, performed by the central processing unit. For that purpose, each intersite link is allocated a weight equal to the sum of the hypertext links that underlie the intersite link, so as to highlight the sites that are greatly linked to each other. It is advantageous to allocate above all a weight to each of the hypertext links that underlie an intersite link, then to allocate the intersite link a weight equal to the sum of the weights allocated to the hypertext links. This second method (equivalent to the first one when an equal weight is allocated to each hypertext link) enables the process of weighting the intersite links to be refined by applying different values to the weights of the various hypertext links.

According to one optional aspect of the present invention, the weighting of a hypertext link linking two pages belonging to the primary set EP1 is chosen higher than the weighting of a hypertext link linking two pages one of which does not belong to the set EP1. This second type of link has been highlighted during the steps of forming the sets EP1 and ES1 and appears in the matrix B described above as an example (links between an anonymous page and a page of the set EP1, a so-called anonymous page not belonging to the initial set EP1 although it belongs to a site of the set ES1). Therefore, a weight w1 is allocated to the hypertext links that link pages belonging to the initial set of pages EP1 and a weight w2 lower than w1 is allocated to a hypertext link the starting or destination point of which is an anonymous page.

On the example in FIG. 5B, the weight W(1,2) allocated to the link L(1,2) linking the sites s1 and s2 is therefore equal to:

W1,2=3w1+2w2

as the intersite link L(1,2) is underlain by three hypertext links of weight w1 and two links of weight w2, as seen in FIG. 5A.

Again optionally, it is also advantageous to modulate the weighting of the hypertext links by taking into consideration various criteria that give these links value or otherwise. Out of the criteria that may be chosen, the age of a site and the number of pages a site comprises can be cited as examples. Therefore, it can be considered that a hypertext link linking two pages has more “value” when at least one of the two pages belongs to a recent site than when the two pages belong to an old site. Also, it can be considered that a hypertext link has more value when at least one of the two pages belongs to a site comprising a small number of pages than when the two pages belong to a very large site.

The pages in Annex 1 and Annex 2 describe two examples of algorithms implemented by the central processing unit for the weighting of the hypertext links and the weighting of intersite links. In these examples, that are an integral part of the description, the weights wi,j allocated to hypertext links are weighted by linear combination of criteria such as the nature of the link, the age of the page and the size of the site.

The intersite links can also be weighted by the results obtained by means of the filtering. Therefore, for example, the weights of the intersite links concerning the sites belonging to the highest-ranking core or cores are multiplied by a first value k1. In one equivalent alternative, the weights of the hypertext links between pages coming within the sites belonging to the highest-ranking core or cores are multiplied by the value k1. Then, the weights of the intersite links between sites belonging to the lower-ranking core or cores are multiplied by a value k2 lower than k1. In one equivalent alternative, the weights of the hypertext links between pages coming within sites belonging to the lower-ranking core or cores are multiplied by a value k2 lower than k1. This step is repeated for the lower-ranking cores, by reducing the corrective value k each time. As far as the links between sites belonging to two cores of different ranks are concerned, these links can be weighted by a parameter k equal to the average of the values k allocated to the intersite links within each core.

The weighting of the intersite links can also be transformed into weighting the sites, by, for example, allocating each site a weight equal to the sum of the weights of the intersite links that the site considered contains. Therefore, with reference to the example above, the weight allocated to the site s2 is equal to the sum of the weights W(2,6), W(2,5), W(2,4), W(2,3) and W(2,1) allocated to the links linking the site s2 to the other sites of the set ES2.

Generally speaking, the step of weighting the intersite links and/or of weighting the sites is advantageous in that it enables a new ranking of the sites according to the weight of their intersite links (or according to their weight, if the choice has been made to allocate weights to the sites). Therefore, it can occur that sites that are not part of the highest-ranking core or cores have intersite links of higher weight than sites that are part of these cores, due to the fact that they are linked to various cores of different ranks. In other terms, as the cores are defined on the basis of the relations they have within themselves regardless of the links they possibly receive from other cores, taking into account inter-core links enables the selection of sites to be refined. Therefore, a site belonging to a core that has no relation with the other cores will be weakened compared to a site belonging to a core of the same size but that is in relation with other cores.

As the internaut only has access, in practice, to the first 10 to 20 results at the end of a request on a search engine (85% of internauts do not go beyond that), it is essential to filter the large amount of results proposed by the engine by ranking, so as to present only the most relevant pages in these first results.

Display

Once the filtering operation is finished, the results are presented on the monitor 12 of the user's microcomputer 10. The result can be presented classically, for example in the form of a list of Web pages comprising first the pages of the initial set EP1 belonging to the sites of the reduced set ES2′. Optionally, this list may comprise secondly the pages of the initial set belonging to sites that belong to lower-ranking cores, such as the pages of the reduced set ES2″ for example and so on and so forth by reducing the rank of the cores considered each time.

In one alternative, this list presents the sites of the set ES2 by descending values of the weights of the intersite links, which, in this case, have first been calculated and weighted as described above. According to one aspect of the present invention, the sites of the reduced set ES2′ and possibly of the other reduced sets comprising lower-ranking cores, are presented in the form of selectable interactive objects, by simultaneously representing the intersite links between the sites in a form that can be understood by the user, such as in the form of lines for example.

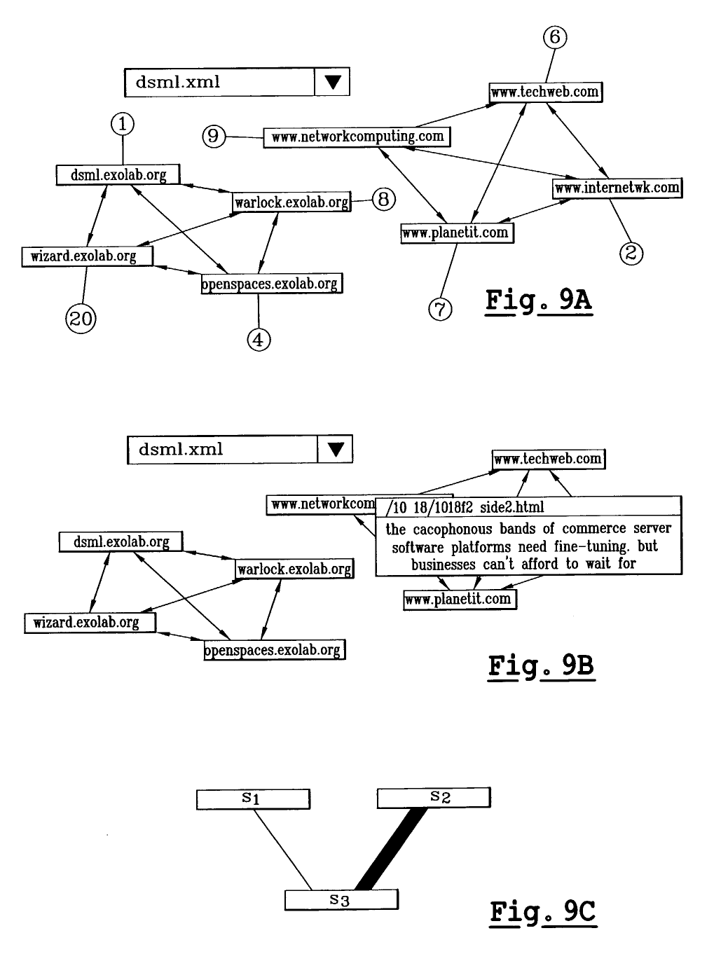

As an example, FIG. 9A represents the display of the result of a search made on the basis of the following search equation:

R1=“dsml”

that aims to search for information about the programming language “dsml”.

The result of the filtering is represented in the form of site objects taking the form of selectable rectangles within which the addresses of the sites are mentioned, the intersite links between the site objects being materialized by arrows. This method of graphical representation combined with the display of the intersite links immediately shows the sites of the core of the set ES2. This representation makes the graph extremely clear and immediately directs the user towards the central sites. The number of sites attached by intersite links to the central sites is represented, for information only, by a number that is encircled. As it can be seen in FIG. 9B, the interactive selection of a site (by means of a monitor pointer and a “click” on the mouse for example) shows the Web pages of the initial set EP1 that belong to the site selected, as well as information relating to these pages (a single page is represented in FIG. 9B as the site selected only comprises one page belonging to the initial set EP1). The pages appearing further to the selection of a site are themselves selectable objects to directly access the content of the pages. The intersite links are also interactive objects the selection of which leads to the display of information (not represented), such as the number of hypertext links that underlie the intersite link or information about the sites linked by the link selected for example. The intersite links are represented by two-way arrows when they are underlain by hypertext links in opposite directions, or by one-way arrows when they are underlain by hypertext links in the same direction. Finally, the intersite links are presented with different colours to inform the user of the number of hypertext links that underlie them, black being for example reserved for the intersite links comprising the highest number of hypertext links, red being reserved for the intersite links comprising less hypertext links, etc.

In the event that the step of determining the weights of the intersite links is performed, with possible weighting of the links according to the rank of the core to which the sites belong, the colour represents the weight allocated to the intersite links rather than the number of underlying hypertext links. As shown in FIG. 9C, it is also possible to replace the various colours by thicknesses of links, one intersite link being more or less thick according to the number of hypertext links that underlie it or according to their weight).

Generally speaking, it results from the above that the combination of the filtering according to the present invention and of the graphical representation of the filtering result in the form of site objects and intersite links, as well as the fact that the selection of a site object leads to the display of the Web pages of the initial set EP1, that are themselves presented in the form of selectable objects, constitute an effective and user-friendly Web page search and selection tool.

It will be understood that various alternatives of this display may be made, it being possible to represent the site objects in different forms, in a two or three-dimensional space. Further, various options can be proposed to the user with a view to adjusting the presentation of the results on the monitor, particularly options concerning the filtering itself. In particular, the user may be given the possibility of changing the selectivity parameter “S” described above at any time and/or the limit rank of the cores that he wishes to be displayed. This parametering of the filtering characteristics enables the user to increase or to reduce the number of sites presented on the monitor.

It will be understood by those skilled in the art that various alternatives and embodiments of the present invention may be made, both as far as the filtering step and the steps of forming the initial set EP1 of Web pages are concerned.

In particular, although it was indicated in the description above that the steps 10, 20 and the filtering step are performed by the central processing unit of a microcomputer, these steps can also be performed by a search engine, such as one of the engines E1, E2 or E3 represented in FIG. 1 for example. In this case, only the display operation is executed by the user's terminal, along with the step of sending the search equation R1. The user's terminal is then relieved of the calculation and filtering operations and can take forms other than a microcomputer, such as a mobile telephone or a television set connected to the Internet for example. In this case, the user's terminal constitutes the “client” that sends a search equation and receives the results of the filtering operation in response.

Furthermore, it results from the above that the features of the present invention relating to the display of the results in the form of site objects remain optional with regard to those relating to the filtering, particularly when they cannot be implemented for technical reasons, which is the case when the user conducts a search by means of a device that only comprises a small display device, like a mobile telephone connected to the Internet. In this case, a display of the results in the form of a list of Web sites can be considered, or even a classical display of a list of Web pages.

Generally speaking, it results from the above that the present invention provides a certain number of tools to analyze and rank an initial set of Web pages having a determined topography, with a short calculation time and small calculation means. These tools comprise the work on Web sites linked by intersite links, the search for the core or cores of the set of Web sites, that may comprise the search for the highest-ranking cores down to the lowest-ranking cores, possibly weighting the intersite links, and weighting the intersite links according to the rank of the cores within which the sites come.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### Annex 1

### Example of an Algorithm for Weighting the Hypertext Links

“pᵢ”=page of rank i

“pⱼ”=page of rank j

“sᵢ”=site to which pᵢ belongs

“sⱼ”=site to which pⱼ belongs

“L(i,j)”=link from pᵢ to pⱼ

“w(i,j)”: weight of the link L(i,j)

“n”=number of pages in EP1

<<CRIT1>=value allocated to the first criterion

<<CRIT2>>=value allocated to the second criterion

<<CRIT3>>=value allocated to the third criterion

a,b,c real positive such as: a+b+c=1

a1 belongs to the set [0,1]

b1 belongs to the set [0,1]

c1 belongs to the set [0,1]

for i ranging from 1 to n

for j ranging from 1 to n

<start>

w(i,j)=0, CRIT1=0, CRIT2=0, CRIT3=0

If “pᵢ” does not designate “pⱼ” go to <loop 1>

If “pᵢ” and “pⱼ” belong to EP1: CRIT1=a1, else CRIT1=1−a1

If age of “sᵢ” and age of “sⱼ” higher than X years: CRIT2=b1 else CRIT2=1−b1

If “sᵢ” and “sⱼ” contain more than Y pages: CRIT3=c1 else CRIT3=1−c1

w(i,j)=a CRIT1+b CRIT2+c CRIT3

<loop 1>

j=j+1

If j≦n: go to <start>

<loop 2>

j=0

i=i+1

If i≦n: go to <start>

end

### Annex 2

### Example of an Algorithm for Weighting the Intersite Links

“sᵢ”=site of rank i

“s”=site of rank j

“pₖ”=pages of rank k

“p₁”=page of rank 1

“jk,1”=hypertext link from “pₖ” to “P₁”

“w(k,1)”=weight of “jk,1”

“L(i,j)”=intersite link from “sᵢ” to “sⱼ”

“W(i,j)”=weight of the link “L(i,j)”

“n”=number of pages in EP1

“m” number of sites in ES1

for k ranging from 1 to n,

for 1 ranging from 1 to n,

for i ranging from 1 to m,

for j ranging from 1 to m,

<start>

W(i,j)=0

If “pₖ” does not designate “pᵢ”: go to <loop 1>

If “pₖ” belongs to “sᵢ” and “p₁” belongs to “sⱼ”: W(i,j)=W(i,j)+w(k,1)

<loop 1>

1=1+1,

If 1≦n: go to <start>

<loop 2>

1=0

k=k+1

If k≦n: go to <start>

<loop 3>

k=1=0

j=j+1,

If j≦m: go to <start>

<loop 4>

k==j=0,

i=i+1

If i≦n: go to <start>

end

### Annex 3

### Integral Part of the Description

ANNEX 3
(integral part of the description)
Table 1 (and FIG. 1)
Step 10
Search for Web pages by means of a search engine,
in conjunction with a search equation, to form an initial set EP1 of Web pages
Step 20
Determination of a first set ES1 of Web sites from the initial set EP1 of Web pages
Step 25
Determination of the intersite links linking the sites of the set ES1
Filtering
(Filtering to search for cores)
Start set:
ES2 = ES1
Destination set:
ES2′ = (ES1)
Display A1
Display of the sites of the set ES2′ as selectable interactive objects
or:
Display of the pages of the initial set EP1 belonging to the sites of the set ES2′
Table 2 (and FIG. 3)
Step 100
Search for Web pages by means of a search engine, in conjunction with a search equation
Result = Primary set P1
Step 200
Extraction of the sites corresponding to the pages of the set P1
Result = primary set S1

| Option 1 | Option 2 |
|---|---|
| Step 110 | Step 120 |
| 110a: Search for Web pages designating at | 120a: Search for Web pages designated by at |
| least one page belonging to a site of the set S1 | least one page belonging to a site of the set |
| and meeting the search equation | S1 and meeting the search equation |
| Result = primary set P2 | Result = primary set P3 |
| 110b: Search for Web pages designating at | 120b: Search for Web pages designated by at |
| least one page of the set P1 and meeting the | least one page of the set P1 and meeting the |
| search equation | search equation |
| Result = primary set P2′ | Result = primary set P3′ |
| Step 210 | Step 220 |
| Extraction of the sites corresponding to the | Extraction of the sites corresponding to the |
| pages of the set P2 | pages of the set P3 |
| Result = primary set S2 | Result = primary set S3 |

```
Step 130
Determination of the initial set of Web pages:
Option 1 [symbol]   EP1 = P1 + P2
Option 2 [symbol]   EP1 = P1 + P3
Option 1 and Option 2 [symbol]
  EP1 = P1 + P2 + P3
Step 230
Determination of the first set of Web sites:
Option 1 [symbol]   ES1 = S1 + S2
Option 2 [symbol]   ES1 = S1 + S3
Option 1 and Option 2 [symbol]
  ES1 = S1 + S2 + S3
Table 3A (and FIG. 8): Search for the core with exhaustion
```

| | |
|---|---|
| Step 300 | Go to 301 |
| Start set ES2, | |
| with ES2 = ES1 | |
| N = 1 | |
| Step 301 | Go to 302 |
| Removal of the sites comprising less than N links with other | |
| sites and removal of the corresponding links | |
| Step 302 | Yes: go to 301 |
| Are there any sites remaining comprising less than N links? | No: go to 303 |
| Step 303 | No: go to 304 |
| ES2 = empty? | Yes: go to 305 |
| Step 304 | Go to 301 |
| N = N + 1 | |
| Step 305 | Go to 306 |
| N_{Z} =N | |
| N_{L} = N_{Z} − S | |
| Step 306 | End |
| Reinsert into ES2 the sites comprising at least N_{L} links with | |
| the other sites | |

uz,10/31 Table 3B: Search for the core with conditional stop

| | |
|---|---|
| Step 300 | go to 301 |
| Start set ES2, | |
| with ES2 = ES1 | |
| N = 1 | |
| Step 301 | go to 302 |
| Removal of the sites designated comprising less than N links | |
| with the other sites and removal of the corresponding links | |
| Step 302 | yes: go to 301 |
| Are there any sites remaining comprising less than N links? | no: go to 303′ |
| Step 303′ | yes: go to 307 |
| Complexity indicator | no: go to 304 |
| DI > K? | |
| Step 304 | go to 301 |
| N = N + 1 | |
| Step 307 | |
| End | |
| N_{L} = N | |

I claim:

1. A Method for searching for and selecting Web pages in conjunction with a search equation, comprising:
determining, through at least one search engine, an initial set of Web pages, and
determining a first set of Web sites comprising sites corresponding to the Web pages of the initial set, wherein sites are linked by intersite links, one site being linked to another site by an intersite link when there is at least one hypertext link between Web pages of the two sites considered,
the step of determining a first set of Web sites comprising at least one filtering operation based on the intersite links, applied to the first set of sites and comprising the elimination of sites linked to the other sites of the first set of sites by less than N_{L} intersite links, N being a filter parameter at least equal to 1, to obtain at least a first reduced set of sites comprising at least one core of rank N_{L} of the first set of sites.

2. Method according to claim 1, wherein a site is linked to another site by a single intersite link when there are several hypertext links in the same direction between Web pages of the two sites considered.

3. Method according to claim 1, wherein a site is linked to another site by a single intersite link when there are hypertext links in opposite directions between Web pages of the two sites considered.

4. Method according to claim 1, wherein the filtering operation is conducted by pruning and comprises repeating a step of eliminating sites linked by less than N intersite links, for increasing values of N starting with an initial value N₀ and at least up to the value N_{L}, that defines a filter depth.

5. Method according to claim 1, comprising at least a second filtering operation applied to the first set of sites from which the sites belonging to the first reduced set of sites are removed, to obtain at least a second reduced set of sites comprising lower-ranking cores formed by sites linked by less than N_{L} intersite links.

6. Method according to claim 1, comprising a step of weighting the intersite links of the first set of sites, including allocating a determined weight to each intersite link.

7. Method according to claim 6, comprising weighting the sites by allocating each site a weight equal to the sum of the weights of the intersite links contained in the site considered.

8. Method according to claim 6, wherein weighting an intersite link comprises a step of allocating a determined weight to the hypertext links linking the respective pages of two sites considered, and a step of adding up the weights of each of the hypertext links that underlie the intersite link.

9. Method according to claim 5, wherein an intersite link is weighted according to the rank of the core or cores within which the sites linked by the intersite link come.

10. Method according to claim 6, further comprising a step of ranking sites according to the weights of their intersite links.

11. Method according to claim 1, further comprising a step of presenting, on display means, the sites of at least one reduced set of sites or the pages of the initial set of pages belonging to the sites of at least one reduced set of sites.

12. Method according to claim 1, further comprising presenting Web sites on display means in the form of user-selectable interactive objects, the selection of a site object by a user triggering the display, in the form of selectable interactive objects, of the Web pages belonging to the selected site and to the initial set of pages.

13. Method according to claim 1, further comprising presenting Web sites on display means, with display of the intersite links in a visual form that can be understood by a user.

14. Method according to claim 1, wherein the steps of determining an initial set of pages and a first set of sites comprise the steps of:
searching for pages likely to be relevant with regard to a search equation, to form a first primary set of pages,
determining the sites that correspond to the pages of the first primary set of pages, to form a first primary set of sites,
searching for pages linked to the pages of the first primary set of pages and/or to the sites of the first primary set of sites by hypertext links, to form at least a second primary set of pages,
determining the sites that correspond to the pages of the second primary set of pages, to form at least a second primary set of sites,
merging the first and the second primary sets of pages to form the initial set of pages, and
merging the first and the second primary sets of sites to form the first set of sites.

15. Method according to claim 14, wherein the second primary set of pages comprises pages designating pages belonging to the sites of the first primary set of sites.

16. Method according to claim 14, wherein the second primary set of pages comprises pages designated by pages belonging to the sites of the first primary set of sites.

17. A digital computer configured to execute the method according to claim 1.

18. A computer program recorded on a medium and loadable into the memory of a digital computer configured with a program code executable by the computer, the program code being arranged to execute the steps of the method according to claim 1.
